(19) United States
(12) Patent Application Publication
(10) Pub. No.: US 2009/0093226 A1
(43) Pub. Date: Apr. 9, 2009

(54) RECEIVING APPARATUS AND METHOD

(75) Inventor: Shigeru Amano, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 12/206,791

(22) Filed: Sep. 9, 2008

(30) Foreign Application Priority Data
Oct. 4, 2007 (JP) 2007261211

(51) Int. Cl. H04B 1/18

(52) U.S. Cl. 455/150.1

(57) ABSTRACT

The present invention provides a broadcast signal receiving apparatus and method both capable of reducing the influence of noise generated inside the receiving apparatus. A CPU transmits control information about an optimum TS output rate corresponding to a received channel signal to an OFDM-LSI, based on each output rate setting table stored in a memory in advance. The OFDM-LSI sets an optimum output rate and transmits a signal in accordance with the set optimum output rate.

### BACKGROUND OF THE INVENTION

The present invention relates to a receiving apparatus and a receiving method, and particularly to a broadcast signal receiving apparatus and method capable of reducing the influence of noise generated inside the receiving apparatus.

There has generally been known a broadcast for mobile users by digital terrestrial television broadcasting, which is commonly called “One Seg”.

A receiving apparatus for receiving such a broadcast signal and data is accompanied by a problem that since it is subjected to the influence of various noise upon the transfer of the signal and data, characteristic degradation is brought about.

In order to cope with the above problem on a facsimile, there has been known a technique which acquires an EQM (Eye Quality Monitor) value of data received from outside, fetches or reads a data transmission rate from each stored table, based on the EQM value and corrects its transmission rate (refer to, for example, patent documents 1 (Japanese Unexamined Patent Publication No. 2000-312242) and 2 (Japanese Unexamined Patent Publication No. Hei 10(1998)-248006)).

In order to cope with the above problem on an optical data communication network, there has been known a technique which repeats the monitoring of a communication state for each predetermined time and changes a signal transmission rate, based on the detected state (refer to, for example, a patent document 3 (Japanese Unexamined Patent Publication No. 2007-36607)).

On the other hand, a numerical value of −110 dBm (1 segment conversion) is provided with respect to −112 dBm attainable as a theoretical value in the one seg broadcasting as described above. However, this shows a state in which noise generated within the receiving apparatus is far large. FIG. 10 shows a schematic configuration of a cellular phone 80 as a receiving apparatus that receives one seg broadcasting. A TS interface 84 or the like corresponding to an interface that demodulates and decodes a broadcast signal received by a tuner LSI 82 via an antenna 86 and outputs it as information about video, voice and the like, exists in the cellular phone 80.

The generation of noise at a portion or area where the inside of the cellular phone 80, particularly, a reception front-end unit (module) is subjected to its influence strongly, occurs due to a change or the like in output bus such as the TS interface 84. Thus, in order to cope with the noise generated thereinside, a reduction in drive capacity and varying of the drive capacity according to a mounting environment have been conducted. A problem, however, arises in that when a harmonic wave of the TS interface 84 is just overlaid on the frequencies of the input/output or the like of the tuner LSI 82, the influence of noise cannot be reduced.

### SUMMARY OF THE INVENTION

The present invention has been made to solve the above problems. It is an object of the present invention to provide a broadcast signal receiving apparatus and method both capable of reducing the influence of noise generated inside the receiving apparatus.

According to a first aspect of the invention, for attaining the above object, there is provided a receiving apparatus comprising front-end means including tuner means for receiving a broadcast signal and communication means for outputting a modulated broadcast signal obtained by modulating the broadcast signal inputted from the tuner means, output control means for controlling an output device in such a manner that information based on the modulated broadcast signal outputted from the communication means is outputted therefrom, optimum output rate setting means for setting an optimum value of an output rate at which the communication means outputs the modulated broadcast signal, for every channel of the broadcast signal, and output rate control means for controlling the communication means, based on the optimum output rate set by the output rate setting means.

A receiving apparatus according to a second aspect is provided wherein in the receiving apparatus according to the first aspect, the front-end means is shielded.

A receiving apparatus according to a third aspect is provided wherein in the receiving apparatus according to the first or second aspect, the tuner means is shielded.

A receiving apparatus according to a fourth aspect is provided wherein in the receiving apparatus according to any one of the first through third aspects, there is provided optimum output rate storing means having stored therein optimum output rates for every channel in advance and wherein the optimum output rate setting means sets an optimum value based on the optimum output rates stored in the optimum output rate storing means in advance, and the output control means shares the output rate control means.

A receiving apparatus according to a fifth aspect is provided wherein in the receiving apparatus according to any one of the first through fourth aspects, the front-end means is provided therewithin with optimum output rate storing means having stored therein optimum output rates for every channel in advance, the optimum output rate setting means sets an optimum value, based on the optimum output rates stored in the optimum output rate storing means in advance, and the output rate control means is included in the communication means.

A receiving apparatus according to a sixth aspect is provided wherein in the receiving apparatus according to any one of the first through fifth aspects, the optimum output rate setting means acquires quality information on the broadcast signal inputted to the communication means by the tuner means every output rate and sets an optimum value, based on the quality information acquired.

A receiving apparatus according to a seventh aspect is provided wherein in the receiving apparatus according to the sixth aspect, there is provided means for making determination as to a stable state of the broadcast signal inputted to the communication means by the tuner means and wherein the output rate setting means acquires the quality information when it is determined by the determining means that the stable state of the broadcast signal is satisfactory, and sets the optimum value, based on the quality information acquired.

A receiving apparatus according to an eighth aspect is provided wherein in the receiving apparatus according to the sixth or seventh aspect, the output rate setting means sets the optimum value for every predetermined time during reception of the broadcast signal by the tuner means.

According to a ninth aspect of the invention, for attaining the above object, there is provided a receiving method comprising the steps: a broadcast signal receiving step for receiving a broadcast signal by tuner means provided in front-end means, a modulated broadcast signal outputting step for outputting a modulated broadcast signal obtained by modulating the broadcast signal inputted from the tuner means, through communication means provided in the front-end means, an output device control step for causing output control means to control an output device in such a manner that information based on the modulated broadcast signal outputted through the communication means is outputted from the output device, an optimum output rate setting step for causing optimum output rate setting means to set an optimum value of an output rate at which the communication means outputs the modulated broadcast signal, for every channel of the broadcast signal, and an output rate control step for causing output rate control means to control the communication means based on the optimum value set by the output rate setting means.

A receiving method according to a tenth aspect is provided wherein in the receiving method according to the ninth aspect, the optimum output rate setting step sets an optimum value, based on optimum output rates stored in optimum output rate storing means in advance for every channel.

A receiving method according to an eleventh aspect is provided wherein in the receiving method according to the ninth or tenth aspect, the optimum output rate setting step acquires quality information on the broadcast signal inputted to the communication means by the tuner means for every output rate and sets an optimum value, based on the quality information acquired.

According to the present invention described in the first and ninth aspects, an advantageous effect is brought about in that since an output rate at which a modulated broadcast signal is outputted from communication means provided in front-end means is set to an optimum output rate, and the output thereof is controlled so as to be made based on the optimum output rate, the influence of noise generated inside a receiving apparatus can be reduced.

According to the present invention described in the second aspect, an advantageous effect is brought about in that since the front-end means is shielded, the influence of noise, e.g., the influence of noise generated due to a high-speed transmission signal line or the like for transmitting a signal to an output device can be prevented.

According to the present invention described in the third aspect, an advantageous effect is brought about in that since tuner means is shielded, it is preferable to prevent the influence of noise, e.g., the influence of noise generated in a high-speed transmission signal line or the like for transmitting a signal to an output device.

According to the present invention described in the fourth aspect, an advantageous effect is brought about in that since there is provided optimum output rate storing means having stored therein optimum output rates for every channel in advance, an optimum rate can be set based on the stored optimum output rates, and since output control means shares output rate control means, it can perform the setting and control of an optimum output rate promptly.

According to the present invention described in the fifth aspect, an advantageous effect is brought about in that since there is provided optimum output rate storing means having stored therein optimum output rates for every channel in advance, an optimum rate can be set based on the stored optimum output rates, and since the output rate control means is included in the communication means, it can perform the setting and control of an optimum output rate promptly inside the front-end means.

According to the present invention described in the sixth aspect, an advantageous effect is brought about in that since quality information about a broadcast signal inputted to the communication means by the tuner means is acquired every output rate, and an optimum output rate is set based on the acquired quality information, the setting and control of each optimum output rate can be performed in real time in accordance with the state of quality of the broadcast signal.

According to the present invention described in the seventh aspect, an advantageous effect is brought about in that since there is provided means for making determination as to a stable state of the broadcast signal inputted to the communication means by the tuner means, and the output rate is set to an optimum output rate, based on quality information where the stable state of the broadcast signal is satisfactory, the setting and control of the optimum output rate can be performed more accurately.

According to the present invention described in the eighth aspect, an advantageous effect is brought about in that since an optimum output rate can be set for every predetermined time during reception of the broadcast signal, the setting and control of the optimum output rate can be performed depending on the influence of noise changed even in the case where noise has changed during reception.

According to the present invention described in the tenth aspect, an advantageous effect is brought about in that since an optimum output rate is set based on output rates stored in output rate storing means in advance for every channel, the setting and control of each optimum output rate can be performed promptly.

According to the present invention described in the eleventh aspect, an advantageous effect is brought about in that since quality information about a broadcast signal inputted to communication means by tuner means is acquired for every output rate, and an optimum output rate is set based on the acquired quality information, the setting and control of the optimum output rate can be performed in real time in accordance with the state of quality of the broadcast signal.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a diagram showing a schematic configuration of a receiving apparatus according to a first preferred embodiment of the present invention;

FIG. 2 is a flowchart for describing a TS output rate setting operation of the receiving apparatus according to the first preferred embodiment of the present invention;

FIG. 3 is a diagram illustrating a schematic configuration of a receiving apparatus according to a second preferred embodiment of the present invention;

FIG. 4 is a flowchart for describing a TS output rate setting operation of the receiving apparatus according to the second preferred embodiment of the present invention;

FIG. 5 is a diagram depicting a schematic configuration of a receiving apparatus according to a third preferred embodiment of the present invention;

FIG. 6 is a flowchart for describing a TS output rate setting operation of the receiving apparatus according to the third preferred embodiment of the present invention;

FIG. 7 is a diagram for describing one example of a decision as to a stable state of a signal transmitted from a tuner LSI to an OFDM-LSI in the third preferred embodiment of the present invention;

FIG. 8 is a diagram for describing a method for calculating an MER value of the signal transmitted from the tuner LSI to the OFDM-LSI in the third preferred embodiment of the present invention;

FIG. 9 is a diagram for describing one example of a correspondence relationship between information about the quality of a signal transmitted from the tuner LSI being held temporarily to the OFDM-LSI and a TS output rate in the third preferred embodiment of the present invention; and

FIG. 10 is a diagram for describing the generation of internal noise by a cellular phone according to a prior art.

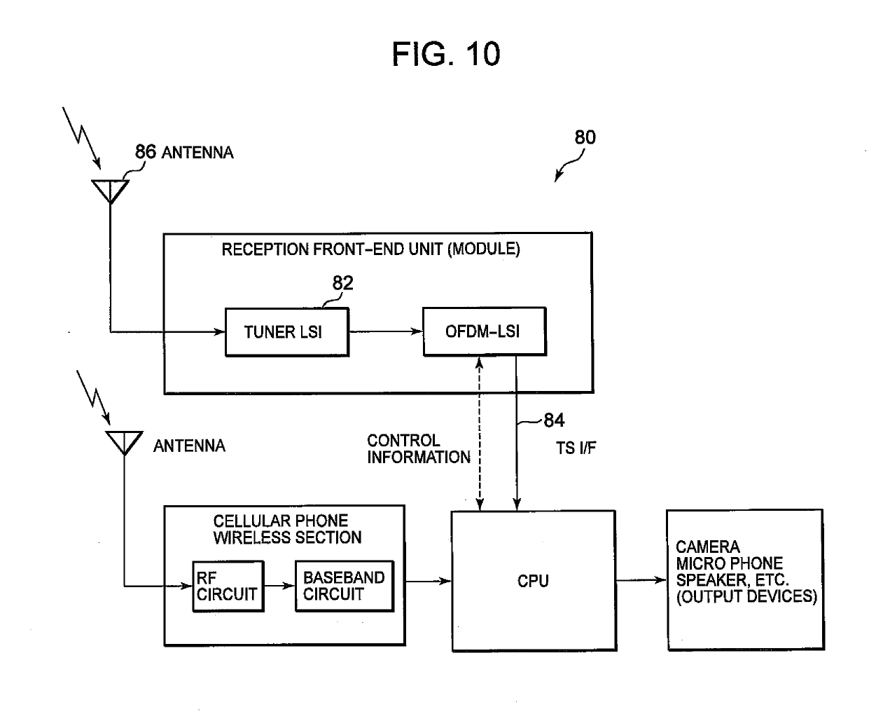

### DETAILED DESCRIPTION OF THE PREFERRED EMBODIMENTS

Preferred embodiments of the present invention will hereinafter be described in detail with reference to the accompanying drawings.

### First Preferred Embodiment

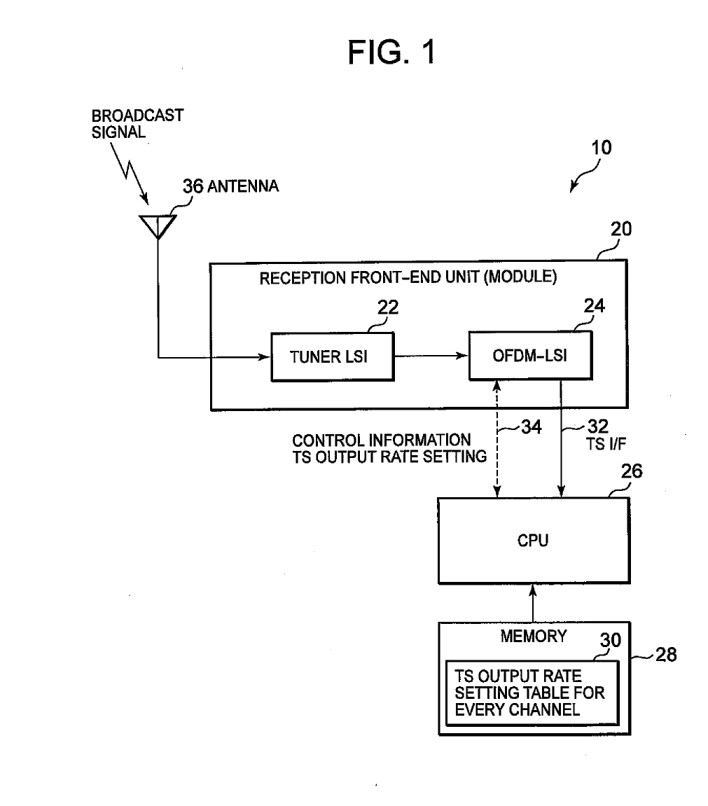

FIG. 1 is a configuration diagram showing one example of a schematic configuration of a receiving apparatus 10 according to a first preferred embodiment of the present invention. Incidentally, although the present embodiment explains the case in which the receiving apparatus is of a cellular phone, only parts necessary for explanations will be described in FIG. 1.

The receiving apparatus 10 according to the present embodiment comprises a reception front-end unit (module) 20 including a tuner LSI 22 and an OFDM-LSI (Orthogonal Frequency Division Multiplexing-LSI) 24, a CPU 26, a memory 28 and an antenna 36.

The tuner LSI 22 receives a broadcast signal inputted from the antenna 36. The OFDM-LSI 24 demodulates and decodes the broadcast signal outputted from the tuner LSI 22 and outputs the same to the CPU 26 via a TS (Transport Stream) I/F (hereinafter called “TS interface”) 32 as information about video, voice and captions or the like.

The CPU 26 transmits control information for setting TS output rates corresponding to channels of the broadcast signal to the OFDM-LSI through a signal line 34, based on TS output rate setting tables (hereinafter called “output rate setting tables”) provided every channel, which have been stored in the memory 28 in advance. The CPU 26 controls output devices such as a camera, a microphone, a DSP and a speaker or the like (any not shown in the figure) to cause the output devices to output (display) the information about the video, voice and captions or the like, based on the signal inputted from the OFDM-LSI 24. Further, the CPU 26 control the entire apparatus in the receiving apparatus (cellular phone) 10 according to the present embodiment.

The output rate setting tables 30 have been stored in the memory 28 in advance. Incidentally, the output rate setting table 30 is equivalent to one represented in the form of a table by obtaining in advance TS output rates at which MER values, SNR values, BER values or the like to be described later are optimized every channel of the broadcast signal by the known output signal analytical soft or signal level meter or the like. Incidentally, the calculation of the MER values will be described later in detail in a third preferred embodiment. Incidentally, the optimum TS output rate corresponds to, for example, a TS output rate at the time that a signal most reduced in the influence of noise is obtained.

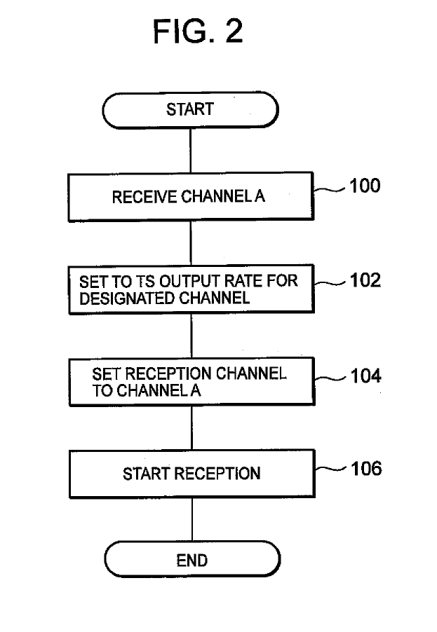

The operation of the receiving apparatus 10 according to the present embodiment will next be explained with reference to FIG. 2. FIG. 2 is a flowchart for describing a TS output rate setting operation of the receiving apparatus 10. Incidentally, the TS interface 32 of the present embodiment can take an interface by outputting signals (data) intermittently if the required lowest rate or more is taken.

When the TS output rate setting operation is started, the tuner LSI 22 first receives a channel A via the antenna 36 at Step 100. At the next Step 102, the CPU 26 outputs a TS output rate for the channel A read from the corresponding output rate setting table 30 of the memory 28 to the OFDM-LSI 24 and thereby sets an output rate of the OFDM-LSI 24.

At the next Step 104, the reception channel of the tuner LSI 22 is set to the channel A. At the next Step 106, the reception of a broadcast signal is started and the present processing is ended.

Incidentally, although the flowchart shown in FIG. 2 has explained the case where the channel A is received, the present invention is not limited to it. The TS output rate may be set for each channel similarly even in the case where other channels are received. Thus, in the present embodiment, the influence of noise can be treated individually for every channel.

Incidentally, the TS output rate might be set to the same value in the case of different channels. In this case, the TS output rates brought to the optimum (subjected to the least noise effect or influence) are identical regardless of channels and contained in the corresponding output rate setting table 30.

Further, the reception front-end unit 20 is shielded by a metal such as aluminium thereby to make it possible to prevent the influence of noise, for example, the influence of noise generated by a high-speed transmission signal line (not shown) for transmitting signals to the output devices (not shown). In this case, the tuner LSI 22 may preferably be shielded in particular.

Although a bus interface corresponding to the TS interface 32 of the MPEG-2 standard is used as the interface for outputting each signal from the OFDM-LSI 24 to the CPU 26 in the present embodiment, the present invention is not limited to it. The interface may be a bus capable of outputting demodulated and decoded data.

Although the present embodiment has explained the case where the receiving apparatus 10 is of the cellular phone, the present invention is not limited to it. The receiving apparatus may be a receiving apparatus that receives other digital signals or the like therein.

According to the receiving apparatus 10 of the present embodiment as described above, the CPU 26 transmits the control information about the optimum TS output rate corresponding to the received channel signal to the OFDM-LSI 24, based on each output rate setting table 30 stored in the memory 30 in advance. The OFDM-LSI 24 sets the optimum output rate and transmits the signal in accordance with the set optimum output rate. It is therefore possible to reduce the influence of noise generated inside the receiving apparatus. In particular, the influence of noise due to a variation in output bus can be reduced.

### Second Preferred Embodiment

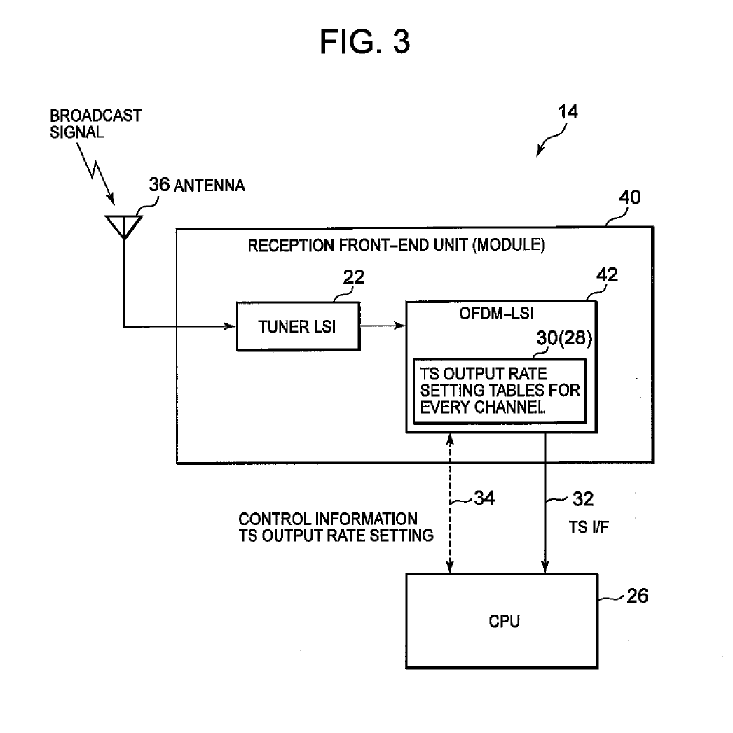

A second preferred embodiment of the present invention will be described below in detail with reference to the drawings. FIG. 3 is a configuration diagram showing one example of a schematic configuration of a receiving apparatus 14 according to the present embodiment. While the present embodiment explains the case in which the receiving apparatus is of a cellular phone, only parts necessary for explanations are described in FIG. 3. Since the present embodiment is substantially similar to the first preferred embodiment in configuration and operation, the same portions are respectively given the same reference numerals and their detailed explanations will therefore be omitted.

The receiving apparatus 14 according to the present embodiment comprises a reception front-end unit (module) 40 including a tuner LSI 22 and an OFDM-LSI 42, a CPU 26 and an antenna 36.

The OFDM-LSI 42 of the present embodiment comprises output rate setting tables 30 (memory 28 with each output rate setting table 30 stored therein) included in an integrated circuit. As to the tuner LSI 22 known to have already been used at the stage of design of the receiving apparatus 14, the frequency subjected to the influence of noise is well defined. Therefore, each optimum TS output rate based on it has been stored in the output rate setting table 30 in advance.

Although not shown in FIG. 3, the memory 28 (each output rate setting table 30) may be connected to the CPU 26 in a manner similar to the first preferred embodiment.

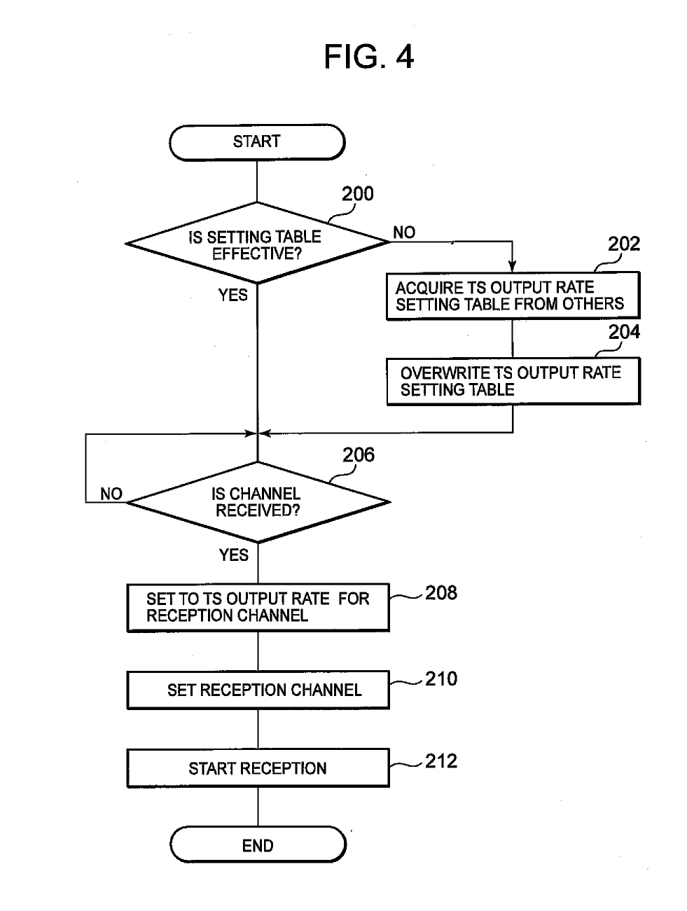

The operation of the receiving apparatus 14 according to present embodiment will next be explained with reference to FIG. 4. FIG. 4 is a flowchart for describing a TS output rate setting operation of the receiving apparatus 14.

When the TS output rate setting operation is started, it is first determined at Step 200 whether the setting table is effective. While the optimum TS output rates obtained at the stage of design have been stored in the corresponding output rate setting table 30 as described above in the present embodiment, the output rate setting table is not effective where the optimum TS output rates are different at the design stage due to part replacement or the like. Therefore, the answer at Step 200 is denied and the TS output rate setting operation proceeds to Step 202.

At Step 202, a TS output rate setting table 30 (TS output rates corresponding to all channels) for a broadcast signal is acquired from others. In the present embodiment, the TS output rates are acquired from the memory 28 (output rate setting table 30) connected to the CPU 26 in a manner similar to the first preferred embodiment by way of example. At the next Step 204, the output rate setting table 30 of the OFDM-LSI 42 is overwritten with the acquired output rate setting table. Thus, the output rate setting table 30 with the optimum TS output rate stored therein is brought to a state of being stored in the OFDM-LSI 42. Thus, when the TS output rate setting operation is performed next time, the answer at Step 200 referred to above is determined to be affirmative.

When the answer at Step 200 is found to be affirmative, the TS output rate setting operation proceeds to Step S206. It is determined at Step 206 whether a channel (broadcast signal) has been received. When it is determined that the channel has not been received, the answer at Step 206 is denied and the receiving apparatus is brought to a standby state. When it is determined that the channel has been received, the answer at Step 206 is assumed to be affirmative and the TS output rate setting operation proceeds to Step 208.

At Step 208, the TS output rate corresponding to the received channel is read from the corresponding output rate setting table 30 and set. At the next Step 210, the reception channel of the tuner LSI 22 is set to the received channel. At the next Step 212, the reception of a broadcast signal is started and the present processing is terminated.

According to the receiving apparatus 14 of the present embodiment as described above, each output rate setting table 30 is included in the OFDM-LSI 42 and the optimum TS output rate is set for each received channel, based on the output rate setting table. It is therefore possible to set the optimum TS output rate and transmit a signal based on the same even where the TS output rate is not subjected to control by the CPU 26. Thus, the influence of noise generated inside the receiving apparatus can be reduced.

Since the TS output rate may not be placed under the control by the CPU 26 as described above, the influence of noise can be reduced even upon scanning of a broadcast wave. The broadcast wave scan means that a signal inputted from the tuner LSI 22 is scanned for every channel in turn and whether the signal is receivable is determined, thereby setting the receivable channel. Described specifically, there are cited methods described in, for example, Japanese Unexamined Patent Publication Nos. 2004-179928 and 2005-333190, but no limitations are imposed on the same. Upon the broadcast wave scan, the reception front-end unit 40 is autonomously operated without being placed under the control by the CPU 26. In the present embodiment, the influence of noise can be reduced even upon the broadcast wave scan because the TS output rate can be set to the optimum value and outputted even without being placed under the control by the CPU 26.

### Third Preferred Embodiment

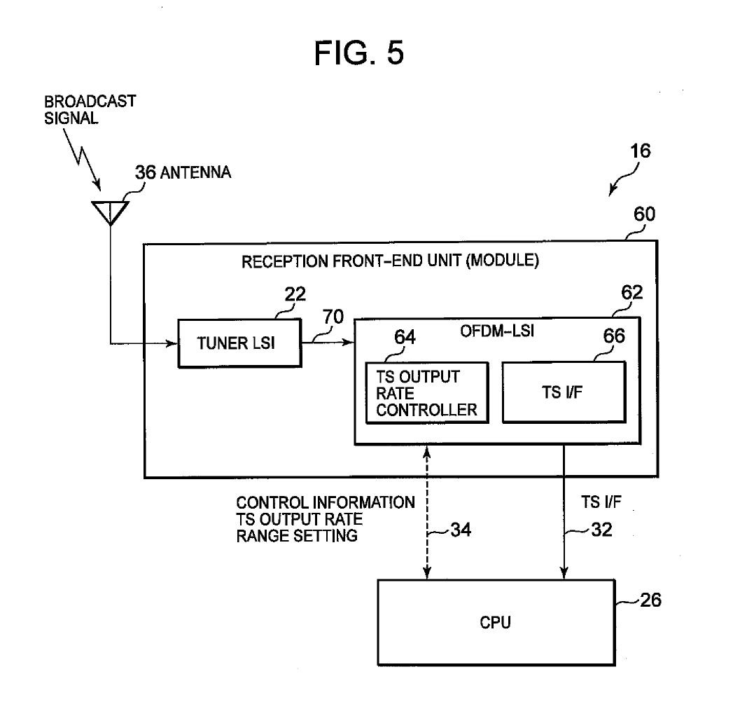

A third preferred embodiment of the present invention will be described below in detail with reference to the drawings. FIG. 5 is a configuration diagram showing one example of a schematic configuration of a receiving apparatus 16 according to the present embodiment. The present embodiment aims to reduce the influence of noise for a tuner LSI 22, resulting from a TS interface 32.

Incidentally, although the present embodiment explains the case in which the receiving apparatus is of a cellular phone, only parts necessary for explanations will be described in FIG. 5. Since the present embodiment is substantially similar to the first preferred embodiment in configuration and operation, the same portions are respectively given the same reference numerals and their detailed explanations will therefore be omitted.

The receiving apparatus 16 according to the present embodiment comprises a reception front-end unit (module) 60 including a tuner LSI 22 and an OFDM-LSI 62, a CPU 26 and an antenna 36.

The OFDM-LSI 62 of the present embodiment comprises a TS output rate controller 64 and a TS interface 66 included within an integrated circuit.

The TS output rate controller 64 controls an TS output rate at which the TS interface 66 outputs a signal through a TS interface 32.

Incidentally, the CPU 26 of the present embodiment transmits control information such as a TS output rate possible or allowable range, etc. to the OFDM-LSI 62 (the details thereof will be described later).

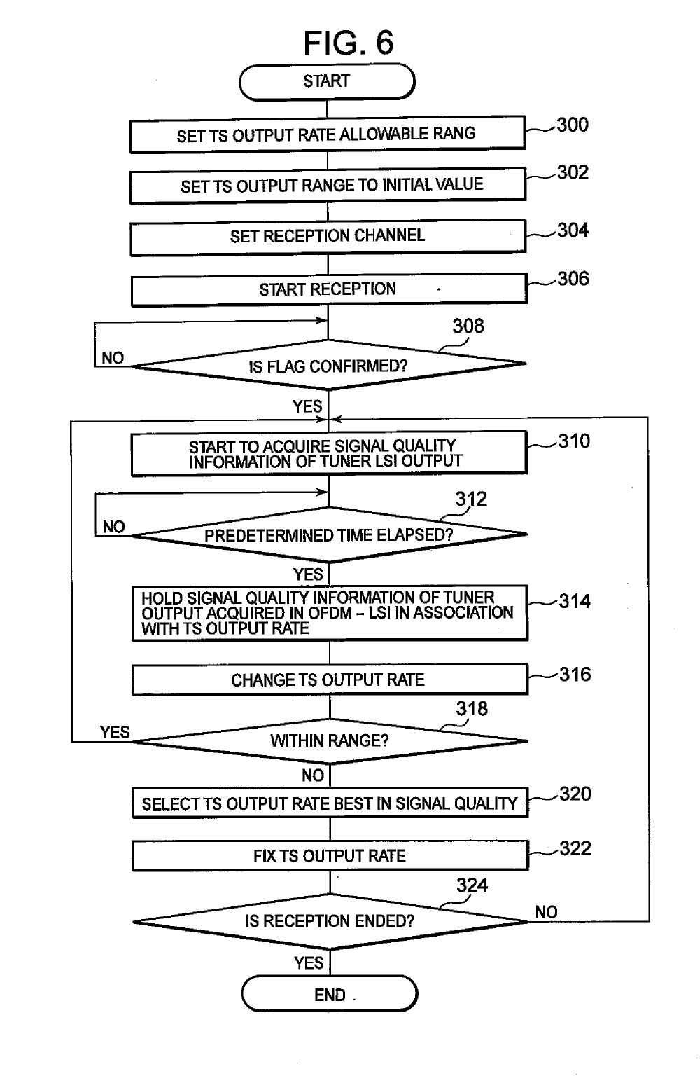

The operation of the receiving apparatus 16 according to the present embodiment will next be described with reference to FIG. 6. FIG. 6 is a flowchart for describing a TS output rate setting operation of the receiving apparatus 16.

When the TS output rate setting operation is started, a TS output rate allowable range is first set based on the control information transmitted from the CPU 26 at Step 300. The TS output rate allowable range is of a range of TS output rates at which interfaces can be taken at the receiving apparatus 16 according to the present embodiment and is equivalent to one obtained in advance.

At the next Step 302, the TS output rate is set to an initial value. Incidentally, the initial value may include, for example, the highest value or lowest value or the like in the TS output rate allowable range in the present embodiment, but is not limited to it. At the next Step 304, a reception channel of the tuner LSI 22 is set. At the next Step 306, the reception of a broadcast signal for the set channel is started and the TS output rate setting operation proceeds to Step 308.

It is determined at Step 308 whether a flag has been confirmed. In the present embodiment, the TS output rate controller 64 determines whether a signal 70 transmitted from the tuner LSI 22 to the OFDM-LSI 62 is stable. If it is determined that the signal 70 has been stable, then a flag is generated.

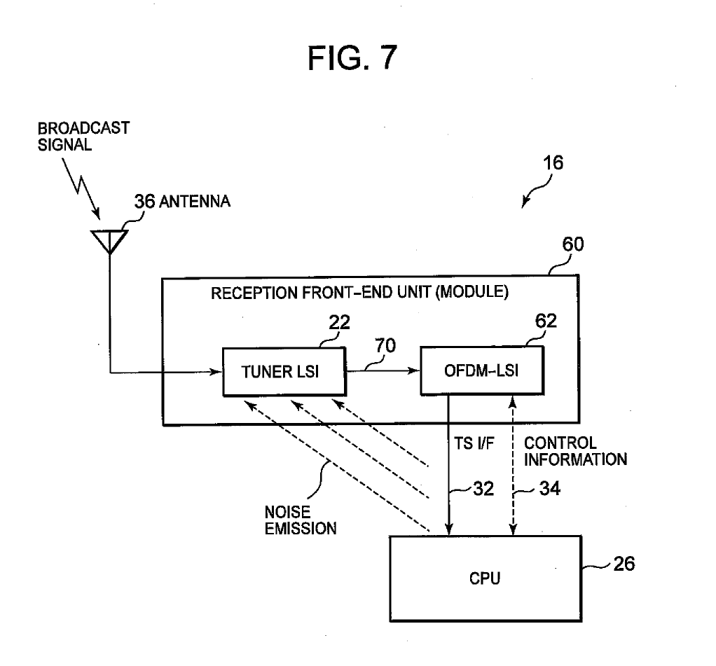

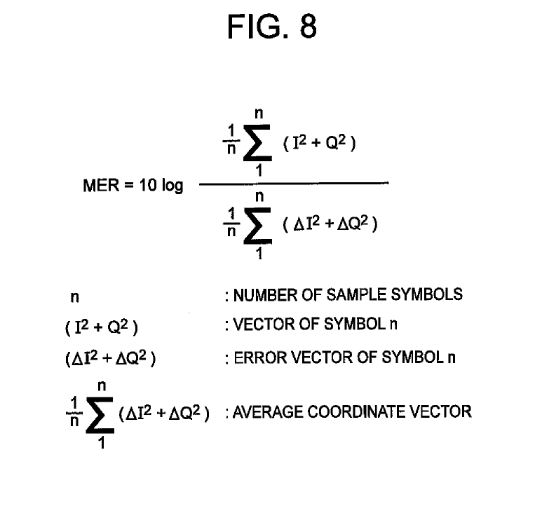

One example of a decision as to whether the signal 70 transmitted from the tuner LSI 22 to the OFDM-LSI 62 is stable will now be described in detail with reference to FIGS. 7 and 8.

FIG. 7 is a diagram for describing the decision about the stable state of the signal 70 transmitted from the tuner LSI 22 to the OFDM-LSI 62. Since the signal 70 is affected by the emission of noise for the tuner LSI 22, resulting from the TS interface 32 as shown in FIG. 7, the signal 70 causes degradation due to noise characteristics. However, whether the state of reception of the signal 70 is stable, is determined regardless of the presence or absence of noise.

In the present embodiment, the above decision is done based on a MER (Modulation Error Rate) value of the signal 70. Incidentally, the MET value is of a value defined from ideal constellation points as a power ratio between a power conversion value of a vector error and each ideal constellation point at demodulated constellations. A method of calculating the MER value of the signal 70 in the present embodiment is shown in FIG. 8. The MER value can be calculated using the computational formula shown in FIG. 8. In the present embodiment, a decision as to whether the calculated MER value falls within a predetermined stable range is made. When it falls within the stable range, it is determined that the state of reception is stable, and a flag is generated. When it is beyond the stable range, it is determined that the state of reception is not stable, and no flag is generated. Incidentally, when the state of reception is unstable, the calculation of a MER value and a decision as to whether it falls within the stable range, are conducted again after a predetermined time has elapsed.

Preferably, the MER value is calculated plural times at a predetermined TS output rate and the state of reception is determined depending on whether it falls within the stable rate over a predetermined number of times.

Thus, when it is not possible to confirm the generation of the flag, the answer to the flag confirmation is denied at Step 308 and a standby state is reached. On the other hand, when the flag generated in the above-described manner is confirmed, the answer to the flag confirmation is affirmative and the TS output rate setting operation proceeds to Step 310.

At Step 310, the acquisition of signal quality information about the output (signal 70) of the tuner LSI 22 is started. Incidentally, the signal quality information may be defined as the MER value as in the case where one example is shown above, but is not limited to it. For instance, an SNR value, a BER (Bit Error Rate) value or the like may be used.

It is determined at the next Step 312 whether a constant time has elapsed. The answer at Step 312 is denied until the predetermined constant time elapses, and a standby state is reached. On the other hand, when the constant time has elapsed, the answer at Step 312 is assumed to be affirmative and the TS output rate setting operation proceeds to Step 314. At Step 314, the TS output rate controller 64 associates the signal quality information about the signal 70 in the OFDM-LSI 62 with the set TS output rate and temporarily store the same therein. Incidentally, preferably, the signal quality information is acquired plural times in a state in which the TS output rate is held constant, and the average value thereof is retained.

At the next Step 316, the TS output rate is changed. Incidentally, to which extent the TS output rate should be changed (to what value it is set) may be set in advance. It is determined at the next Step 318 whether the changed TS output rate falls within the TS output rate allowable range set at Step 300. When the TS output rate is found to fall within the TS output rate allowable range, the answer at Step 318 is affirmative and the TS output rate setting operation is returned to Step 310, where similar processing is repeated and the signal quality information on the signal 70 is associated with each TS output rate and temporarily stored.

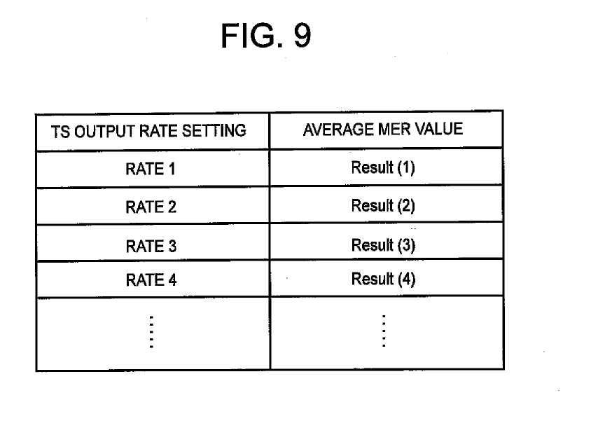

One example of a correspondence relationship between the temporarily held signal quality information about the signal 70 and the TS output rate is shown in FIG. 9. In FIG. 9, rates 1 through 4 are of TS output rates different from one another. Results (1) through (4) corresponding to average MER values are respectively associated with the TS output rates as the signal quality information.

On the other hand, when the TS output rate changed at Step 318 is found not to fall within the TS output rate allowable range, the answer at Step 318 is denied and the TS output rate setting operation proceeds to Step 320. At Step 320, the TS output rate best in signal quality is selected. In the present embodiment, the best value of the Results (1) through (4) shown in FIG. 9, e.g., the value close to the ideal value that assumed not to be subjected to the influence of noise is selected. At the next Step 322, the selected TS output rate is set and fixed. Thus, a signal is outputted from the OFDM-LSI 62 in accordance with the set TS output rate.

At the next Step 324, it is determined whether the reception of a broadcast signal should be terminated. The answer at Step 324 is denied during reception and the TS output rate setting operation is returned to Step 310 where the present processing is repeated. Namely, the setting and control of the optimum output rate are repeated during reception of the broadcast signal. On the other hand, when the reception of the broadcast signal is ended, the answer at Step 324 is affirmative and the present processing is ended. Incidentally, the temporarily held correspondence relationship illustrative of one example in FIG. 9 is deleted after the completion of the present processing.

Incidentally, although the setting and control of the optimum output rate have been conducted by the TS output rate controller 64 provided inside the OFDM-LSI 62 in the present embodiment, the present invention is not limited to it. The TS output rate controller 64 may be provided outside the OFDM-LSI 62 or may be provided outside the reception front-end unit 60.

The output rate setting table is further provided as in the first preferred embodiment and may be controlled by the CPU 26. Alternately, the output rate setting table may be provided inside the OFDM-LSI 62 as in the second preferred embodiment. This is preferred because it is available for the setting of each TS output rate to the initial value where the signal broadcast is received, the setting at the time that the signal 70 is not brought to a stable state, and the like.

According to the receiving apparatus 16 of the present embodiment as described above, the TS output rate controller 64 performs control so as to select the optimum TS output rate for each predetermined period during the reception of the broadcast signal, make setting to the selected TS output rate and output the signal. Therefore, the optimum TS output rate can be set in real time. It is thus possible to reduce the influence of noise generated inside the receiving apparatus.

Since the optimum TS output rate can be selected by the TS output rate controller 64 in the present embodiment, it is not necessary to provide the output rate setting table (the memory that stores the table therein). Therefore, the size corresponding to its area can be cut down. Accordingly, the receiving apparatus 16 can be brought into less size.

When a variation in reception level, fading and the like occur in a reception input level and the like, the result obtained is unstable even though the subsequent signal quality is confirmed. Therefore, a case occurs in which the TS output rate cannot be set to the optimum value even though the choice of each TS output rate is conducted. This is not preferred eventually. Since, however, the selection of the TS output rate is performed where the signal 70 is stable in the present embodiment, the TS output rate can be set to the optimum value.

While the preferred forms of the present invention have been described, it is to be understood that modifications will be apparent to those skilled in the art without departing from the spirit of the invention. The scope of the invention is to be determined solely by the following claims.

1. A receiving apparatus comprising:
front-end means including tuner means for receiving a broadcast signal and communication means for outputting a modulated broadcast signal obtained by modulating the broadcast signal inputted from the tuner means;
output control means for controlling an output device in such a manner that information based on the modulated broadcast signal outputted from the communication means is outputted therefrom;
optimum output rate setting means for setting an optimum value of an output rate at which the communication means outputs the modulated broadcast signal, for every channel of the broadcast signal; and
output rate control means for controlling the communication means, based on the optimum output rate set by the output rate setting means.

2. The receiving apparatus according to claim 1, wherein the front-end means is shielded.

3. The receiving apparatus according to claim 1, wherein the tuner means is shielded.

4. The receiving apparatus according to claim 1, further including optimum output rate storing means having stored therein optimum output rates for every said channel in advance,
wherein the optimum output rate setting means sets an optimum value, based on the optimum output rates stored in the optimum output rate storing means in advance, and
wherein the output control means shares the output rate control means.

5. The receiving apparatus according to claim 1, wherein the front-end means is provided therewithin with optimum output rate storing means having stored therein optimum output rates for every said channel in advance,
wherein the optimum output rate setting means sets an optimum value, based on the optimum output rates stored in the optimum output rate storing means in advance, and
wherein the output rate control means is included in the communication means.

6. The receiving apparatus according to claim 1, wherein the optimum output rate setting means acquires quality information on the broadcast signal inputted to the communication means by the tuner means every output rate and sets an optimum value, based on the quality information acquired.

7. The receiving apparatus according to claim 6, further including means for making determination as to a stable state of the broadcast signal inputted to the communication means by the tuner means,
wherein the output rate setting means acquires the quality information when it is determined by the determining means that the stable state of the broadcast signal is satisfactory, and sets the optimum value, based on the quality information acquired.

8. The receiving apparatus according to claim 6, wherein the output rate setting means sets the optimum value for every predetermined time during reception of the broadcast signal by the tuner means.

9. A receiving method comprising the steps:
a broadcast signal receiving step for receiving a broadcast signal by tuner means provided in front-end means;
a modulated broadcast signal outputting step for outputting a modulated broadcast signal obtained by modulating the broadcast signal inputted from the tuner means, through communication means provided in the front-end means;
an output device control step for causing output control means to control an output device in such a manner that information based on the modulated broadcast signal outputted through the communication means is outputted from the output device;
an optimum output rate setting step for causing optimum output rate setting means to set an optimum value of an output rate at which the communication means outputs the modulated broadcast signal, for every channel of the broadcast signal; and
an output rate control step for causing output rate control means to control the communication means based on the optimum value set by the output rate setting means.

10. The receiving method according to claim 9, wherein the optimum output rate setting step sets an optimum value, based on optimum output rates stored in optimum output rate storing means in advance for every said channel.

11. The receiving method according to claim 9, wherein the optimum output rate setting step acquires quality information on the broadcast signal inputted to the communication means by the tuner means for every output rate and sets an optimum value, based on the quality information acquired.
